(19) United States
(12) Patent Application Publication
(10) Pub. No.: US 2009/0326142 A1
(43) Pub. Date: Dec. 31, 2009

(54) AQUEOUS DISPERSION OF STRUCTURED POLYMER, MANUFACTURING PROCESS AND USE IN COATING FORMULATIONS

(76) Inventors: Mathias Agnely, Paris (FR); Wojciech Bzducha, Courbevoie (FR); Arnaud Cadix, Paris (FR); Jean-Francois Colombet, Rueil-Malmasion (FR)

Correspondence Address: HEXION SPECIALTY CHEMICALS, INC., 12650 Directors Drive, Suite 100, Stafford, TX, 77477, US

(21) Appl. No.: 11/996,631

(22) PCT Filed: Jul. 20, 2006
(86) PCT No.: PCT/EP06/07165

§ 371 Date: Aug. 13, 2009

(30) Foreign Application Priority Data
Jul. 29, 2005 (FR) 05/08167

(51) Int. Cl. C08L 33/08

(52) U.S. Cl. 524/523; 524/500

(57) ABSTRACT

The invention concerns the field of aqueous dispersions. It concerns in particular an aqueous dispersion based on structured polymer comprising at least two phases, one called soft with low Tg and the other called hard with high Tg. The invention also concerns the use of such dispersions, as binder in formulation for paints free of solvents or coalescent agents.

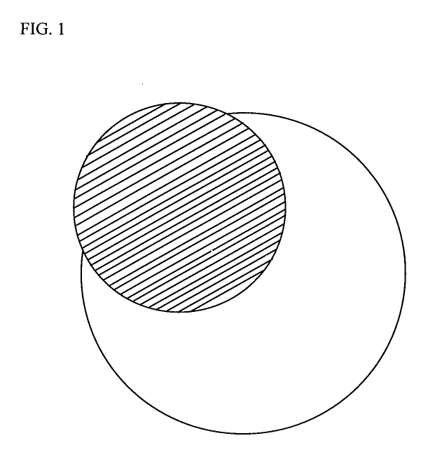

The present invention relates to the field of aqueous dispersions of structured polymers comprising at least one polymer with a low glass transition temperature and at least one polymer with a high glass transition temperature, which dispersions are intended to be used as binders in paint formulations.

The properties which characterize a good gloss paint formulation are good ease of application, good binding power on various types of substrates (bare walls or even walls covered with old layers of paint, wood, paper, and the like), determined by the elasticity and the adhesion of the binder, film formation at low temperature (˜5° C.), good resistance to soiling, good resistance to wet abrasion (washability), good resistance to blocking and a suitable specular gloss.

Generally, water paint compositions comprise a polymer as binder and pigments. After application to the substrate to be treated and drying of the composition, the film forms by coalescence of the particles. The quality of the film depends on good coalescence. This is generally favoured by the addition of solvents which are coalescence agents. They plasticize the particles of polymers, thus reducing the temperature of formation of the paint film. These coalescence agents make it possible to use polymers which do not normally form a film at the temperature at which the paint is applied. After drying, they are gradually removed by evaporation. The paint film thus gradually hardens and thus acquires advantageous properties: good resistance to wet abrasion, good resistance to blocking, and the like. Unfortunately, there are disadvantages to these coalescence agents. They are volatile products, in particular if their boiling point is low: they contribute to polluting the atmosphere. If, on the other hand, their boiling point is high, they are removed very gradually, which results in a very slow development of the hardness of the film. In this case, the properties, such as the resistance to blocking in the period following the application of the paint, are limited. Furthermore, these paints do not conform to the standards, such as those referred to as “Nordic Swan” or “Blue Angel”.

The use of conventional latexes based on polymers of low Tg, which thus form films at temperatures of approximately 0° C., makes it possible to solve these problems in the case of matt paints, where the level of polymers is low. On the other hand, for gloss paints, which for their part have a high level of polymers, the use of these latexes causes problems related to the inadequate hardness of the paint film.

Mention may be made, among the solutions provided to solve the problems mentioned above, for example, of JP56116759 (Daicel Chemical Ind.), which discloses polymer acrylic emulsions prepared by multistage polymerization, so that 50-97% of the polymer prepared in the first stage has a glass transition temperature (Tg)<−20° and 3-50% prepared in the final stage has a Tg>+20°. The acrylic emulsions according to this document are of use as coating materials.

EP 0522789 discloses an elastomer composition comprising a sequential latex, the Tg of the soft part of which is less than −30° C. and the level of which is more than 70%. Furthermore, the difference between the two Tg values is greater than 40° C.

EP 0728154 B1 discloses, positioning itself with respect to the abovementioned document (EP 0522789), an aqueous dispersion of structured particles of polymer comprising at least one first polymer with a Tg1 of between −25° C. and 0° C. and at least one polymer 2 with a Tg2 of between 5 and 40° C. The monomers participating in the polymers 1 and 2 are chosen so that Tg2−Tg1 is less than or equal to 40° C.

The Applicant Company has found that the solution to these problems and to many others is the use of an aqueous dispersion based on structured polymer exhibiting two distinct glass transition temperatures which is obtained by the two-stage emulsion polymerization of mixtures of well-chosen monomers.

A first subject-matter of the present invention is thus an aqueous dispersion of polymers in the form of structured particles with a mean diameter of between 70 and 300 nm comprising at least one polymer exhibiting a glass transition temperature (Tg1) of between −50° C. and 0° C., representing from 30 to 70% by weight of the total weight of the particles, and at least one second polymer having a glass transition temperature (Tg2) of between 10 and 80° C., representing from 70 to 30% by weight of the total weight of the particles. The polymers 1 and 2 are defined such that Tg2−Tg1 is greater than or equal to 40° C.

According to a preferred form of the invention, the polymers 1 and 2 are mutually incompatible.

The term “incompatibility” is understood to mean the existence at least of two separate phases of the copolymers in the same particle having a structured morphology.

The structured particles according to the invention can have any morphology of structured particles. In particular, they can be provided in the form of a core-shell morphology or in the form of a multicore structure, in the form of a multicellular nodule or in the “hazelnut” form, one polymer phase of which incompletely surrounds the second. Examples of these structures have been described by D. C. Sundberg and Y. G. Durant in “Polymer Reaction Engineering”, vol. 11, No. 3, pp. 379-432 (2003).

The incompatibility can be determined by the use, optionally in conjunction, of various techniques, such as:

DSC—differential scanning calorimetry is employed to determine the thermal transitions of the various phases in structured materials. For each phase of the polymer, the change in heat capacity observed at the Tg is proportional to the amount of this phase.

DMA—dynamic mechanical analysis provides the dynamic moduli as a function of the temperature. The mechanical transitions (Tg) of the various phases of the structured materials can be accessed by this method.

TEM—transmission electron microscopy is the most commonly used method to visualize the domains of the structured particles. Observation may be carried out either on whole particles or on sections of particles obtained by techniques such as cryofracturing.

NMR—nuclear magnetic resonance spectroscopy, in particular of solids, provides important information relating to the internal composition of the various phases and interphases of the structured particles. The technique is based on the measurement of the spin relaxation times of the protons, which depend on the glass transition temperature of the phase.

The glass transition temperatures (Tgs) can be determined by various techniques, in particular by DSC and by DMA.

Preferably, the particles of the invention display a structure of “hazelnut” type by TEM, as represented diagrammatically in the drawing below.

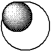

According to the invention, the polymers 1 and 2 are prepared from a mixture of monomers comprising at least one ethylenically unsaturated monomer chosen from (meth)acrylic acid esters and vinyl monomers, such as vinyl acetate and vinylaromatic monomers, and also the monomers which can copolymerize with them.

Mention may also be made, as nonlimiting examples of monomers which can copolymerize with vinyl acetate and/or acrylic esters and/or styrene, of ethylene and olefins, such as isobutene; vinyl esters of saturated and straight or branched monocarboxylic acids having from 1 to 12 carbon atoms, such as vinyl propionate, “vinyl versatate” (vinyl neodecanoate), vinyl pivalate or vinyl laurate; esters of unsaturated mono- or dicarboxylic acids having 3 to 6 carbon atoms with alkanols having 1 to 10 carbon atoms, such as methyl maleate, ethyl maleate, butyl maleate, ethylhexyl maleate, methyl fumarate, ethyl fumarate, butyl fumarate or ethylhexyl fumarate; vinylaromatic monomers, such as methylstyrenes or vinyltoluenes; vinyl halides, such as vinyl chloride or vinylidene chloride; diolefins, particularly butadiene; (meth)allyl esters of (meth)acrylic acid; (meth)allyl esters of the mono- and diesters of maleic acid, fumaric acid and itaconic acid; and alkene derivatives of the amides of acrylic acid and methacrylic acid, such as N-methallylmaleimide.

The monomers forming the first polymer can be identical to or different from those forming the second polymer. This is because a person skilled in the art knows to select the monomers to be polymerized and to define their proportions according to the properties which he wishes to give to the polymer being prepared. Thus, a person skilled in the art, by applying the Fox law (T. G. Fox, Bull. Am. Physic. Soc., vol. 1, No. 3, page 123, year 1956), knows to select the mixture of monomers to be polymerized in order to confer the desired Tg on the polymer being prepared.

Each polymer participating in the composition of the aqueous dispersion of the invention can additionally comprise at least one functional monomer chosen from:
The monomers capable of contributing better colloidal stability to the latex, such as carboxylic acids which are copolymerizable and mono- or difunctional, acrylamide and its derivatives, methacrylamide and its derivatives, monomers comprising a sulphate and sulphonate functional group, such as the sodium salt of 1-allyloxy-2-hydroxypropylsulphonate (Sipomer COPS-I) or the sodium salt of 1-methallyloxy-2-hydroxypropylsulphonate, or monomers comprising a hydroxyl functional group, such as hydroxyethyl acrylate or hydroxyethyl methacrylate.
Phosphate-comprising monomers which make it possible to obtain good adhesion to metal surfaces, such as vinylphosphonic acid, 2-(methacryloyloxy)ethylphosphonic acid (RN 80730-17-2) or 2-(acryloyloxy)ethylphosphonic acid; 2-(methacryloyloxy)ethyl phosphate of formula CH2═C(CH3)(COO)C2H4OPO3H, or 2-(acryloyloxy)ethyl phosphate of formula CH2═CH(COO)C2H4OPO3H; or by Laporte, or their mixture.
Functional monomers capable of contributing good properties of resistance to water and to solvents or for conferring, on latex, specific adhesion properties. Mention may be made, as example, of 1-methacrylamido-2-imidazolidinoneethane, sold under the trade name Sipomer WAM II by Rhodia, glycidyl methacrylate, vinyltriethoxysilane or the vinyl monomers carrying a cyclodextrin group (1-methacrylamido-2-imidazolidinoneethane makes it possible to improve the adhesion of the latex composition to substrates exhibiting carbonyl groups, for example substrates made of polyesters, or old layers of paints of alkyd type).
Monomers which make it possible to improve the adhesion of the latex composition to glass or other inorganic substrates of metal oxide type. Mention may be made, as example, of vinyltriethoxysilane, C4-C 10 esters of acrylic acid, such as n-butyl acrylate, or

According to a preferred form of the invention, the polymer 1 and the polymer 2 are prepared from a monomer mixture comprising:
a. from 5 to 90% by weight of at least one monomer (a) chosen from styrene or methyl methacrylate,
b. from 10 to 95% by weight of at least one monomer (b) chosen from 2-ethylhexyl acrylate.
c. from 0 to 5% by weight of at least one functional monomer, such as acrylic acid, methacrylic acid, itaconic acid, fumaric acid, hydroxyethyl acrylate, hydroxyethyl methacrylate, acrylamide, methacrylamide, the sodium salt of 1-allyloxy-2-hydroxypropylsulphonate (Sipomer COPS-I), the sodium salt of 1-methallyloxy-2-hydroxypropylsulphonate or 1-methacrylamido-2-imidazolidinoneethane (Sipomer WAM II).

More preferably still, the polymer 1 is prepared from a mixture of monomers comprising:

i. from 5 to 45% of at least one monomer (a),

ii. from 55 to 95% of at least one monomer (b), and

iii. from 0 to 5% of at least one monomer (c).

For its part, the polymer 2 is prepared from a mixture comprising:

i. from 55 to 90% of at least one monomer (a),

ii. from 10 to 45% of at least one monomer (b), and

iii. from 0 to 5% of at least one monomer (c).

As described above, the mixtures of monomers are defined so as to confer the required properties, in particular the desired Tg values, on the polymers being prepared.

Furthermore, the composition is arranged so that the difference between Tg2 and Tg1 is greater than or equal to 40 and preferably between 45 and 100° C.

The dispersion of the invention is prepared by radical emulsion polymerization according to a process in at least two stages comprising an emulsion polymerization stage, resulting in the polymer 1, and another polymerization stage, resulting in the polymer 2, characterized in that:
I. the mixtures of monomers to be polymerized during the first stage and the second stage are defined so as to confer, on one of the two polymers, a Tg of between −50° C. and 0° C. and, on the other polymer, a Tg of between 10° C. and 80° C., and
II. the amounts of monomers involved are such that the polymer 1 represents from 30 to 70% by weight and the polymer 2 from 70 to 30% by weight of the total weight of the particles, and
III. the polymerization operating conditions are arranged so as to have polymer particles with a mean diameter of between 70 and 300 nm.

Generally, the mixtures of monomers to be polymerized do not comprise crosslinking monomers. However, the addition, to the first stage or to the second stage, of 0 to 5% by weight of at least one crosslinking monomer, such as 1,2-ethylene glycol dimethacrylate, 1,4-butylene glycol dimethacrylate, trimethylolpropane triacrylate, allyl methacrylate, diallyl phthalate, divinylbenzene or triallyl cyanurate, is not ruled out.

As indicated above, the mixtures of monomers can comprise up to 5% by weight of at least one functional monomer.

During one stage, the polymerization is carried out of a mixture of monomers comprising:

i. from 5 to 45% of at least one monomer (a),

ii. from 55 to 95% of at least one monomer (b), and

iii. from 0 to 5% of at least one monomer (c).

The mixture introduced during the other stage comprises:

from 55 to 90% of at least one monomer (a),

from 10 to 45% of at least one monomer (b), and

from 0 to 5% of at least one monomer (c).

The polymerization of the first stage is carried out in the presence of a surfactant and of a initiator, which are introduced all at once as initial charge into the reactor in the form of an aqueous solution.

The solutions of surfactant and of initiator can also be added simultaneously with the addition of monomers.

The surfactant which is used can be any surfactant conventionally used for emulsion polymerization processes.

The surfactants which can be used are anionic, cationic or nonionic emulsifiers. Use may be made of one surfactant alone or a mixture of several surfactants.

Use is generally made, as surfactant, of conventional anionic surfactants represented in particular by alkyl sulphates, such as sodium lauryl sulphate, alkylsulphonates, alkylaryl sulphates, alkylaryl-sulphonates, such as sodium dodecylbenzenesulphonate, aryl sulphates, arylsulphonates, alkyl ethoxylates, alkylaryl ethoxylates, sulphated or phosphated alkyl ethoxylates or alkylaryl ethoxylates or their salts, sulphosuccinates, alkali metal alkyl phosphates, salts of hydrogenated or nonhydrogenated abietic acid, or fatty acid salts, such as sodium stearate.

Use is preferably made of anionic or nonionic surfactants.

They are generally employed in a proportion of 0.01 to 5% by weight, with respect to the total weight of the monomers.

It is also possible to couple the use of one of the anionic surfactants mentioned above with a water-soluble nonionic polymer, such as, for example, poly(vinyl alcohol) or polyvinylpyrrolidone (PVP).

It is also possible to couple the use of one of the anionic surfactants mentioned above with a stabilizing system based on synthetic anionic polymers, for example poly((meth)acrylic acid), poly(meth)acrylamide, poly(vinylsulphonic acid)s and water-soluble copolymers of these, or condensates, such as sulphonated melamine/formaldehyde or sulphonated naphthalene/formaldehyde, styrene/maleic acid copolymers and vinyl ether/maleic acid copolymers.

The monomers constituting each of the phases of the dispersion can be simply introduced into the reactor in the form of a homogeneous mixture of monomers or can be emulsified using at least one surface-active agent.

The polymerization can be initiated either by the thermal decomposition of a radical initiator, such as sodium persulphate or potassium persulphate, or by a redox system composed of a pairing of an oxidizing agent and of a reducing agent. Mention may be made, as examples of redox system, of: sodium persulphate/sodium disulphite; t-butyl hydroperoxide/sodium formaldehydesulphoxylate; t-butyl perbenzoate/erythorbic acid; hydrogen peroxide/erythorbic acid; H2O2/Fe2+; ROOH/Ce4+ (where R represents an organic group, such as a C1-C6 alkyl or C5-C8 aryl group) or K2S2O8/Fe2+.

The initiators are added at a level of between 0.05 and 3% by weight, with respect to the monomers used.

Preferably, the first stage is initiated by a thermal initiator.

The polymerization of the first stage is carried out at a temperature of between 60 and 95° C.

According to the invention, the introduction of the monomers of the second stage begins when the conversion of the monomers of the first stage is greater than 95% and preferably greater than 97%.

Preferably, the main mixture of the monomers constituting the second polymer of the dispersion is emulsified using at least one surface-active agent. It is preferable to use anionic or nonionic surfactants.

Preferably, the second stage is polymerized using a redox initiator.

The oxidizing agent is chosen from the group consisting of peroxides and hydroperoxides, such as t-butyl perbenzoate and t-butyl hydroperoxide. Preferably, the oxidizing agent is introduced during the synthesis of the first stage.

Preferably, the solution of reducing agent is added simultaneously with the addition of monomers of the second stage.

The polymerization of the second stage is carried out at a temperature of between 40 and 95° C.

The amount of water used in the reaction medium is generally determined by the level of solids desired in the dispersion and generally lies between 40 and 70%, preferably between 45 and 60%.

The polymer emulsion after the second stage can be subjected to treatment by an additional redox initiation system for the purpose of reducing the level of residual monomers. It can also be purified by steam distillation of the volatile organic compounds (stripping).

The pH of the latex is adjusted to a value slightly greater than 7 using alkaline substances, for example sodium hydroxide or potassium hydroxide, for good compatibilization with the other ingredients of the paint formulation.

The dispersion of the invention is used in coatings, such as varnishes or paints, for applications on walls and ceilings, frontages, wood, tiles, and the like. It is preferably used as binder in varnish and paint formulations devoid of solvents or coalescence agents. Another of the subject-matters of the invention is a paint formulation devoid of solvent or coalescence agent comprising the dispersion of the invention.

A representative formulation is specified in Table 1 and an outline manufacturing procedure is given below.

The preparation of the paint comprising the dispersion of the invention follows the following protocol:
constituents 5 to 9 (see Table 1 below) are dispersed at high speed to a fineness <10 μm (pigment paste),
the premix of constituents 2 to 4 is added to 1 with stirring and then the pigment paste is added,
the formulation is brought to completion by adding constituents 10 to 15 with stirring. Mixing is carried out for 5 min.

TABLE 1

| | CONSTITUENTS | Weight | Function |
|---|---|---|---|
| 1 | LATEX | 573.85 | binder |
| 2 | WATER | 14.50 | |
| 3 | TEGO FOAMEX 1488 | 1.45 | antifoaming agent |
| 4 | ACRYSOL RM-2020 | 20.00 | associative PU thickener |
| 5 | WATER | 38.63 | |
| 6 | DISPERBYK 190 | 10.30 | dispersing agent |
| 7 | BYK 024 | 0.64 | antifoaming agent |
| 8 | ACRYSOL RM-2020 | 7.73 | associative PU thickener |
| 9 | TITANIUM OXIDE, | 206.05 | TiO₂ pigment |
| | KRONOS 2190 | | |
| 10 | WATER | 15.00 | |
| 11 | BYK 348 | 1.00 | wetting agent |
| 12 | BYK 381 | 8.00 | levelling agent |
| 13 | 10% SODIUM | 2.00 | |
| | HYDROXIDE SOLUTION | | |
| 14 | ACRYSOL RM-8 W | 6.60 | associative PU thickener |
| 15 | WATER | 94.24 | |
| | Total | 1000.00 | |

The invention may be better understood on reading the following examples, which illustrate the invention without limiting the scope thereof.

### EXAMPLES OF THE METHODS OF PREPARATION

The Tg values targeted in the examples below are calculated as mentioned above according to the Fox equation, taking into consideration the main monomers (the groups a and b), by applying the Tg values of the homopolymers given by “Polymer Handbook; Third Edition, 1989” as follows:

Tg=100° C. for polystyrene

Tg=105° C. for poly(methyl methacrylate)

Tg=−54° C. for poly(butyl acrylate)

Tg=−50° C. for poly(2-ethylhexyl acrylate)

These procedures are based on a process which can be broken down into two separate phases, a first stage, which is the preparation of a random copolymer, and a second stage, which is the synthesis of a random copolymer following the first copolymer, in order to obtain the latex comprising structured particles.

This copolymer is synthesized in a 2 litre glass reactor of SVL type. The maximum working capacity of this type of reactor is 1.5 litres. The internal temperature of the reactor is regulated by a cryostat of Huber type. The temperature is measured using a Pt 100 probe which is immersed in the reactor and which is used for the regulation.

The stirrer is a stainless steel anchor stirrer. The rotational speed of the stirrer is of the order of 200 rev/min.

The reactor is also equipped with a reflux device (coil condenser) sufficiently efficient to allow the monomers to reflux without losses of product.

### Example 1

### Preparation of a Latex with a polystyrene-co-poly(2-ethylhexyl acrylate) Phase and a poly(methyl methacrylate)-co-poly(2-ethylhexyl acrylate) Phase

### Stage 1: Preparation of a polystyrene-co-poly(2-ethylhexyl acrylate) Random Copolymer with a Targeted Tg of −30° C.

At the bottom of the vessel, 276.6 g of water, 3.53 g of a 40% solution in water of the surfactant (sodium salt of α-olefinsulphonate), 3.44 g of a 40% solution in water of Sipomer COPS-I and 3.30 g of t-butyl perbenzoate are introduced at ambient temperature and subsequently 4% by weight (13.5 g) of a pre-emulsified mixture 1 comprising:
101.9 g of water, and
5.64 g of a 40% solution in water of the surfactant (sodium salt of α-olefinsulphonate), and
4.40 g of a 50% solution of Sipomer WAM II, and
175.1 g of 2-ethylhexyl acrylate, and
44.9 g of styrene, and
4.40 g of acrylic acid,
   are added.

The reaction mixture obtained is stirred under nitrogen for 30 minutes (200 rev/min). The temperature is subsequently raised to 75° C. and then a solution of 0.230 g of sodium persulphate dissolved in 2.1 g of water is introduced.

The mixture is brought to 80° C.

After 15 minutes, the addition of the remaining amount (96% by weight) of mixture 1 described above is begun.

The addition is continued for 100 minutes.

Simultaneously, for 100 minutes, a mixture 2 comprising:

0.92 g of sodium persulphate,

22.0 g of water,

is added.

After complete addition of the various ingredients, the temperature of the emulsion is brought to 90° C. over 15 minutes and the copolymer emulsion obtained is maintained at 90° C. for one hour.

A sample (˜5 g) is then withdrawn and the particle size of the latex is measured by light scattering (Malvern Zetasizer). The mean diameter obtained is equal to 95 nm.

An analysis of the sample by gravimetric measurement of the dry extract reveals that the conversion of the monomers is greater than 97%.

### Stage 2: Preparation of a Second poly(methyl methacrylate)-co-poly(2-ethylhexyl acrylate) Random Copolymer with a Targeted Tg of +30° C.

The starting material is the emulsified copolymer obtained above in stage 1 after having withdrawn ˜5 g of it for analysis and without having halted the heating.

A pre-emulsified mixture 3 comprising:
152.8 g of water, and
8.46 g of a 40% solution in water of the surfactant (sodium salt of α-olefinsulphonate), and
6.6 g of a 50% solution of Sipomer WAM II, and
117.5 g of 2-ethylhexyl acrylate, and
212.5 g of methyl methacrylate, and
6.60 g of acrylic acid,
   is added to it at 90° C. over 120 minutes.

The addition is continued for 210 minutes.

Simultaneously, the addition is begun of a mixture 4 comprising:

1.65 g of erythorbic acid,

11.0 g of water.

The addition is continued for 240 minutes.

The system is maintained at 90° C. for an additional hour.

Subsequently, the emulsion is cooled to ˜25° C. over 1 hour.

A sample (˜5 g) is then withdrawn and the particle size of the latex is measured by light scattering (Malvern Zetasizer). The mean diameter obtained is equal to 120 nm.

An analysis of the sample by gas chromatography reveals that the conversion of the monomers is greater than 98%.

A DMA analysis (measuring conditions: 861e DMA device from Mettler/Toledo; temperature scanning test from −60 to 120° C. at 3°/min; extension geometry, with test specimens of 10.5×5×0.5 (in mm), with oscillatory stress of 2 μm in amplitude at a frequency of 1 Hz) reveals that the copolymer obtained is characterized by two glass transition temperatures, Tg1=−15° C. and Tg2=+53° C.

The pH of the latex is adjusted at ambient temperature to a value of approximately 7.5 by adding thereto a 10% aqueous sodium hydroxide solution over one hour.

### Example 2

### Preparation of a Latex with a poly(methyl methacrylate)-co-poly(2-ethylhexyl acrylate) Phase and a poly(methyl methacrylate)-co-poly(butyl acrylate) Phase

### Stage 1: Preparation of a poly(methyl methacrylate)-co-poly(2-ethylhexyl acrylate) Random Copolymer with a Targeted Tg of +30° C.

At the bottom of the vessel, 276.6 g of water, 3.53 g of a 40% solution in water of the surfactant (sodium salt of α-olefinsulphonate), 3.44 g of a 40% solution in water of Sipomer COPS-I and 3.30 g of t-butyl perbenzoate are introduced at ambient temperature and subsequently 4% by weight (16.8 g) of a pre-emulsified mixture 1 comprising:
127.3 g of water, and
7.05 g of a 40% solution in water of the surfactant (sodium salt of α-olefinsulphonate), and
5.50 g of a 50% solution of Sipomer WAM II, and
97.6 g of 2-ethylhexyl acrylate, and
177.4 g of methyl methacrylate, and
5.50 g of acrylic acid,
   are added.

The reaction mixture obtained is stirred under nitrogen for 30 minutes (200 rev/min). The temperature is subsequently raised to 75° C. and then a solution of 0.290 g of sodium persulphate dissolved in 2.60 g of water is introduced.

The mixture is brought to 80° C.

After 15 minutes, the addition of the remaining amount (96% by weight) of mixture 1 described above is begun.

The addition is continued for 120 minutes.

Simultaneously, for 120 minutes, a mixture 2 comprising:
1.14 g of sodium persulphate,
27.5 g of water,
   is added.

After complete addition of the various ingredients, the temperature of the emulsion is brought to 90° C. over 15 minutes and the copolymer emulsion obtained is maintained at 90° C. for one hour.

A sample (˜5 g) is then withdrawn and the particle size of the latex is measured by light scattering (Malvern Zetasizer). The mean diameter obtained is equal to 118 nm.

An analysis of the sample by gravimetric measurement of the dry extract reveals that the conversion of the monomers is greater than 97%.

### Stage 2: Preparation of a Second poly(methyl methacrylate)-co-poly(butyl acrylate) Random Copolymer with a Targeted Tg of −30° C.

The starting material is the emulsified copolymer obtained above in stage 1 after having withdrawn ˜5 g of it for analysis and without having halted the heating.

A pre-emulsified mixture 3 comprising:
132.6 g of water, and
6.05 g of a 60% solution in water of the surfactant (oxyethylenated fatty alcohol), and
6.60 g of a 50% solution of Sipomer WAM II, and
210.7 g of butyl acrylate, and
64.35 g of methyl methacrylate, and
2.75 g of acrylic acid,
   is added to it at 90° C. over 180 minutes.

The addition is continued for 180 minutes.

Simultaneously, the addition is begun of a mixture 4 comprising:
1.65 g of erythorbic acid,
11.0 g of water.

The addition is continued for 210 minutes.

The system is maintained at 90° C. for an additional hour.

Subsequently, the emulsion is cooled to ˜25° C. over 1 hour.

A sample (˜5 g) is then withdrawn and the particle size of the latex is measured by light scattering (Malvern Zetasizer). The mean diameter obtained is equal to 141 nm.

An analysis of the sample by gas chromatography reveals that the conversion of the monomers is greater than 98%.

The pH of the latex is adjusted at ambient temperature to a value of approximately 7.5 by adding thereto a 10% aqueous sodium hydroxide solution over one hour.

### Example 3

### Preparation of a Latex with a poly(methyl methacrylate)-co-poly(butyl acrylate) Phase and a polystyrene-co-poly(2-ethylhexyl acrylate) Phase

### Stage 1: Preparation of a poly(methyl methacrylate)-co-poly(butyl acrylate) Random Copolymer with a Targeted Tg of −30° C.

At the bottom of the vessel, 276.6 g of water, 3.53 g of a 40% solution in water of the surfactant (sodium salt of α-olefinsulphonate), 3.44 g of a 40% solution in water of Sipomer COPS-1 and 3.30 g of t-butyl perbenzoate are introduced at ambient temperature and subsequently 4% by weight (16.8 g) of a pre-emulsified mixture 1 comprising:
127.3 g of water, and
7.05 g of a 40% solution in water of the surfactant (sodium salt of α-olefinsulphonate), and
5.50 g of a 50% solution of Sipomer WAM II, and
210.9 g of butyl acrylate, and
64.10 g of methyl methacrylate, and
5.50 g of acrylic acid,
   are added.

The reaction mixture obtained is stirred under nitrogen for 30 minutes (200 rev/min). The temperature is subsequently raised to 75° C. and then a solution of 0.290 g of sodium persulphate dissolved in 2.60 g of water is introduced.

The mixture is brought to 80° C.

After 15 minutes, the addition of the remaining amount (96% by weight) of mixture 1 described above is begun.

The addition is continued for 120 minutes.

Simultaneously, for 120 minutes, a mixture 2 comprising:
1.14 g of sodium persulphate,
27.5 g of water,
   is added.

After complete addition of the various ingredients, the temperature of the emulsion is brought to 90° C. over 15 minutes and the copolymer emulsion obtained is maintained at 90° C. for one hour.

A sample (˜5 g) is then withdrawn and the particle size of the latex is measured by light scattering (Malvern Zetasizer). The mean diameter obtained is equal to 117 nm.

An analysis of the sample by gravimetric measurement of the dry extract reveals that the conversion of the monomers is greater than 97%.

### Stage 2: Preparation of a Second polystyrene-co-poly(2-ethylhexyl acrylate) Random Copolymer with a Targeted Tg of +50° C.

The starting material is the emulsified copolymer obtained above in stage 1 after having withdrawn ˜5 g of it for analysis and without having halted the heating.

A pre-emulsified mixture 3 comprising:
132.6 g of water, and
6.05 g of a 60% solution in water of the surfactant (oxyethylenated fatty alcohol), and
6.60 g of a 50% solution of Sipomer WAM II, and
63.25 g of 2-ethylhexyl acrylate, and
211.8 g of styrene, and
2.75 g of acrylic acid,
   is added to it at 90° C. over 180 minutes.

The addition is continued for 180 minutes.

Simultaneously, the addition is begun of a mixture 4 comprising:
1.65 g of erythorbic acid,
11.0 g of water.

The addition is continued for 210 minutes.

The system is maintained at 90° C. for an additional hour.

Subsequently, the emulsion is cooled to ˜25° C. over one hour.

A sample (˜5 g) is then withdrawn and the particle size of the latex is measured by light scattering (Malvern Zetasizer). The mean diameter obtained is equal to 142 nm.

An analysis of the sample by gas chromatography reveals that the conversion of the monomers is greater than 98%.

The pH of the latex is adjusted at ambient temperature to a value of approximately 7.5 by adding thereto a 10% aqueous sodium hydroxide solution over one hour.

### Example 4

### Preparation of a Latex with a polystyrene-co-poly(butyl acrylate) Phase and a poly(methyl methacrylate)-co-poly(butyl acrylate) Phase

### Stage 1: Preparation of a polystyrene-co-poly(butyl acrylate) Random Copolymer with a Targeted Tg of −35° C.

At the bottom of the vessel, 241.7 g of water, 3.21 g of a 40% solution in water of the surfactant (sodium salt of alkylsulphonic acid) and 3.13 g of a 40% solution in water of Sipomer COPS-I are introduced at ambient temperature and subsequently 14% by weight (29.9 g) of a mixture 1 comprising:
160.8 g of butyl acrylate, and
39.20 g of styrene, and
6.22 g of acrylic acid,
   are added.

The reaction mixture obtained is stirred under nitrogen for 30 minutes (200 rev/min). The temperature is subsequently raised to 75° C. and then a solution of 0.350 g of sodium persulphate dissolved in 3.5 g of water is introduced.

The mixture is brought to 80° C.

After 15 minutes, the addition of the remaining amount (86% by weight) of mixture 1 described above is begun.

The addition is continued for 90 minutes.

Simultaneously, a mixture 2 comprising:
0.82 g of sodium persulphate,
36.0 g of water,
   is added over 90 minutes.

After complete addition of the mixtures 1 and 2, 3.00 g of t-butyl perbenzoate are added. Subsequently, the temperature of the emulsion is maintained at 80° C. for one hour.

A sample (˜5 g) is then withdrawn and the particle size of the latex is measured by light scattering (Malvern Zetasizer). The mean diameter obtained is equal to 95 nm.

A DSC analysis (the measuring conditions: Mettler 822E/200W DSC; thermal cycle: 20° C./min; temperature range: −50° C. to 120° C.; controlled atmosphere: nitrogen; aluminium pan: standard 40 μl) reveals that the copolymer obtained is characterized by a glass transition temperature Tg=−17° C.

An analysis of the sample by gravimetric measurement of the dry extract reveals that the conversion of the monomers is greater than 97%.

### Stage 2: Preparation of a Second poly(methyl methacrylate)-co-poly(butyl acrylate) Random Copolymer with a Targeted Tg of +17° C.

The starting material is the emulsified copolymer obtained above in stage 1 after having withdrawn ˜5 g of it for analysis and without having halted the heating.

A pre-emulsified mixture 3 comprising:
222.0 g of water, and
12.82 g of a 40% solution in water of the surfactant (sodium salt of alkylsulphonic acid), and
10.00 g of a 50% solution of Sipomer WAM II, and
125.0 g of butyl acrylate, and
175.0 g of methyl methacrylate, and
6.00 g of acrylic acid,
   is added to it at 90° C. over 150 minutes.

The addition is continued for 150 minutes.

Simultaneously, the addition is begun of a mixture 4 comprising:
4.00 g of sodium disulphite
15.0 g of water.

The addition is continued for 180 minutes.

The system is maintained at 90° C. for an additional hour.

Subsequently, the emulsion is cooled to ˜25° C. over 1 hour.

A sample (˜5 g) is then withdrawn and the particle size of the latex is measured by light scattering (Malvern Zetasizer). The mean diameter obtained is equal to 130 nm.

An analysis of the sample by gas chromatography reveals that the conversion of the monomers is greater than 98%.

A DSC analysis (the measuring conditions: Mettler 822E/200W DSC; thermal cycle: 20° C./min; temperature range: −50° C. to 120° C.; controlled atmosphere: nitrogen; aluminium pan: standard 40 μl) reveals that the copolymer obtained is characterized by two glass transition temperatures, Tg1=−10° C. and Tg2=+37° C.

The pH of the latex is adjusted at ambient temperature to a value of approximately 7.5 by adding thereto a 10% aqueous sodium hydroxide solution over one hour.

### Example 5 (Comparative)

### Preparation of a Latex with a poly(methyl methacrylate)-co-poly(butyl acrylate) Phase and a polystyrene-co-poly(2-ethylhexyl acrylate) Phase

### Stage 1: Preparation of a poly(methyl methacrylate)-co-poly(butyl acrylate) Random Copolymer with a Targeted Tg of +30° C.

At the bottom of the vessel, 276.6 g of water, 3.53 g of a 40% solution in water of the surfactant (sodium salt of α-olefinsulphonate), 3.44 g of a 40% solution in water of Sipomer COPS-I and 3.30 g of t-butyl perbenzoate are introduced at ambient temperature and subsequently 4% by weight (16.8 g) of a pre-emulsified mixture 1 comprising:
127.3 g of water, and
7.05 g of a 40% solution in water of the surfactant (sodium salt of α-olefinsulphonate), and
5.50 g of a 50% solution of Sipomer WAM II, and
93.50 g of butyl acrylate, and
181.5 g of methyl methacrylate, and
5.50 g of acrylic acid,
   are added.

The reaction mixture obtained is stirred under nitrogen for 30 minutes (200 rev/min). The temperature is subsequently raised to 75° C. and then a solution of 0.290 g of sodium persulphate dissolved in 2.60 g of water is introduced.

The mixture is brought to 80° C.

After 15 minutes, the addition of the remaining amount (96% by weight) of mixture 1 described above is begun.

The addition is continued for 120 minutes.

Simultaneously, for 120 minutes, a mixture 2 comprising:
1.14 g of sodium persulphate,
27.5 g of water,
   is added.

After complete addition of the various ingredients, the temperature of the emulsion is brought to 90° C. over 15 minutes and the copolymer emulsion obtained is maintained at 90° C. for one hour.

A sample (˜5 g) is then withdrawn and the particle size of the latex is measured by light scattering (Malvern Zetasizer). The mean diameter obtained is equal to 97 nm.

An analysis of the sample by gravimetric measurement of the dry extract reveals that the conversion of the monomers is greater than 97%.

### Stage 2: Preparation of a Second polystyrene-co-poly(2-ethylhexyl acrylate) Random Copolymer with a Targeted Tg of −10° C.

The starting material is the emulsified copolymer obtained above in stage 1 after having withdrawn ˜5 g of it for analysis and without having halted the heating.

A pre-emulsified mixture 3 comprising:
132.6 g of water, and
6.05 g of a 60% solution in water of the surfactant (oxyethylenated fatty alcohol), and
6.60 g of a 50% solution of Sipomer WAM II, and
171.1 g of 2-ethylhexyl acrylate, and
104.0 g of styrene, and
2.75 g of acrylic acid,
   is added to it at 90° C. over 180 minutes.

The addition is continued for 180 minutes.

Simultaneously, the addition is begun of a mixture 4 comprising:

1.65 g of erythorbic acid,

11.0 g of water.

The addition is continued for 210 minutes.

The system is maintained at 90° C. for an additional hour.

Subsequently, the emulsion is cooled to ˜25° C. over one hour.

A sample (˜5 g) is then withdrawn and the particle size of the latex is measured by light scattering (Malvern Zetasizer). The mean diameter obtained is equal to 130 nm.

An analysis of the sample by gas chromatography reveals that the conversion of the monomers is greater than 98%.

The pH of the latex is adjusted at ambient temperature to a value of approximately 7.5 by adding thereto a 10% aqueous sodium hydroxide solution over one hour.

### Example 6

Use of the latexes synthesized in Examples 1 to 5 in gloss paint formulations. The paints were prepared according to the procedure described above.

For the paints obtained, the physical characteristics were determined as follows:
the MFFT (minimum film formation temperature) is measured using an MFFT-BAR-60 device from Rhopoint,
the specular gloss is measured under an angle of 20° according to Standard EN ISO 2813,
the resistance to blocking is measured at 23° C. and at 45° C., according to a scale ranging from 0 (very bad) to 10 (very good), by following this procedure:
   application of the paint to a Leneta substrate (150 μm),
   drying at 23° C. for 7 days,
   strips with a width of 2 cm are cut out,
   the strips are affixed 2 by 2, perpendicularly, paint face against paint face,
   a weight of 500 g is applied for 24 h at 23° C. (125 g/cm²),
   the force required to pull apart the 2 strips is evaluated.
The wet adhesion to an aged alkyd background is measured with a scale of grading ranging from 0 (very good) to 10 (very bad) according to the following procedure:
   application of a black alkyd varnish to an asbestos cement substrate,
   drying: 24 h, ambient temperature, +7 days at 50° C.,
   application of the test paint,
   drying at ambient temperature for 7 days,
   application of a wet blotting paper for 3 hours,
   then cross hatch adhesion test. The grade of 0 is assigned if there is no damage to or detachment of the paint.
The resistance to soiling (the scale of grading: 0 (very good) to 100 (very bad)) is measured by colorimetry, via the loss in lightness (L).
Procedure:
   application of iron oxide powder using a brush,
   wiping with paper towels,
   measuring the loss in lightness.
Resistance to deformation on wood in the crack test.
Procedure:
   beech test specimens painted on all the faces (2 layers of paint) are subjected to aging cycles which simulate outdoor weathering. Description of the cycle (total duration: 24 h):
      4 h at 23° C.,
      3 h at 50° C.,
      1 h of immersion in water,
      16 h in a freezer at −20° C.
   Visual observation of the level of deterioration after each cycle: if there is no deterioration after 10 cycles, a grade of 10 is given to the paint.
      The results found are shown in Table 2 below.

TABLE 2

| | Tg1/Tg2 | | | | | | | |
|---|---|---|---|---|---|---|---|---|
| | (° C.) | | | | | | | |
| Latex | according to | MFFT | Gloss, 20° | Blocking | | Wet | | Crack |
| ref. | Fox | (° C.) | on glass | 23° C. | 45° C. | Adhesion | Soiling | test |
| Ex. 1 | −30/+30 | 0 | 63 | 8 | 8 | 1 | 30 | 5 |
| Ex. 2 | +30/−30 | 0 | 55 | 7 | 7 | 0 | 30 | 9 |
| Ex. 3 | −30/+50 | 0 | 60 | 7 | 7 | 1 | 40 | 2 |
| Ex. 4 | −35/+17 | 0 | 64 | 8 | 7 | 0 | 25 | 9 |

| | | | |
|---|---|---|---|
| Ex. 5 | +30/−10 | 19 | the paint does not form a film at low temperature |
| | | | (~+5° C.) |

1. An aqueous dispersion of polymers in the form of structured particles with a mean diameter of between 70 and 300 nm comprising at least one first polymer exhibiting a glass transition temperature (Tg1) of between −50° C. and 0° C., representing from 30 to 70% by weight of the total weight of the particles, and at least one second polymer having a glass transition temperature (Tg2) of between 10 and 80° C., representing from 70 to 30% by weight of the total weight of the particles, wherein the Tg2−Tg1 is greater than or equal to 40° C.

2. The aqueous dispersion of claim 1, wherein the first polymer and the second polymer are prepared from a monomer mixture comprising at least one ethylenically unsaturated monomer chosen from (meth)acrylic acid esters and vinyl monomers.

3. The aqueous dispersion of claim 1, wherein the first polymer and the second polymer are prepared from a mixture of monomers comprising:
a. from 5 to 90% by weight of at least one monomer (a) chosen from styrene or methyl methacrylate,
b. from 10 to 95% by weight of at least one monomer (b) chosen from C₄-C₁₀ esters of acrylic acid, and
c. from 0 to 5% by weight of at least one functional monomer.

4. The aqueous dispersion of claim 3, wherein the first polymer is prepared from a mixture comprising:
i. from 5 to 45% of at least one monomer (a),
ii. from 55 to 95% of at least one monomer (b), and
iii. from 0 to 5% of at least one monomer (c).

5. The aqueous dispersion of claim 3, wherein the second polymer is prepared from a mixture comprising:
i. from 55 to 90% of at least one monomer (a),
ii. from 10 to 45% of at least one monomer (b), and
iii. from 0 to 5% of at least one monomer (c).

6. The aqueous dispersion of claim 1, wherein Tg2−Tg1 is between 45 and 100° C.

7. A process for the preparation of the aqueous dispersion of claim 1, comprising:
a. combining a first mix of monomers in a first polymerization stage to prepare a first polymer, and;
b. combining a second mixture of monomers in a second polymerization stage to prepare a second polymer;
wherein one of the first polymer or the second polymer exhibit a Tg from −50° C. and 0° C. and the other of the first polymer or the second polymer has a Tg from 10° C. and 80° C., and
wherein one of the first polymer or the second polymer represents from 30 to 70% by weight of the total weight of the polymer and the other of the first polymer or the second polymer represents from 70 to 30% by weight of the total weight of the polymer.

8. The process of claim 7, wherein the polymer particles have a mean diameter of between 70 and 300 nm.

9. The process of claim 7, wherein the introduction of the monomers for the second polymerization stage begins when the conversion of the monomers of the first polymerization stage is greater than 95%.

10. The process of claim 7, wherein the polymerization of the second polymerization stage is initiated by a redox system comprising an oxidizing agent and a reducing agent at a temperature of between 40 and 95° C.

11. The process of claim 10, wherein the oxidizing agent is chosen from the group consisting of peroxides and hydroperoxides.

12. The process of claim 10, wherein the oxidizing agent is introduced during the first polymerization stage.

13. (canceled)

14. A paint formulation comprising the aqueous dispersion of claim 1, wherein the paint formulation is devoid of a solvent and of a coalescening agent.

15. The aqueous dispersion of claim 3, wherein the C₄-C₁₀ esters of acrylic acid are comprise n-butyl acrylate or 2-ethylhexyl acrylate.

16. The aqueous dispersion of claim 3, wherein the at least functional monomer is selected from the group consisting of acrylic acid, methacrylic acid, itaconic acid, fumaric acid, hydroxyethyl acrylate, hydroxyethyl meth-acrylate, acrylamide, methacrylamide, the sodium salt of 1 allyloxy-2 hydroxypropyl-sulphonate, the sodium salt of 1 methallyloxy-2 hydroxypropylsulphonate, 1 methacrylamido-2 imidazolidinoneethane and combinations thereof.

17. The process of claim 11, wherein the oxidizing agent comprises T-butyl perbenzoate or T-butyl hydroperoxide.

18. The aqueous dispersion of claim 1, wherein the aqueous dispersion is devoid of a solvent and a coalescening agent.

19. The aqueous dispersion of claim 1, wherein the first polymer and the second polymer are mutually incompatible.
